(19) United States
(12) Patent Application Publication
(10) Pub. No.: US 2026/0053160 A1
(43) Pub. Date: Feb. 26, 2026

(54) COMPOSITION FOR COATING FOOD AND/OR SURFACES OF FOOD PROCESSING MACHINES

(71) Applicant: Capol GmbH, Elmshorn (DE)

(72) Inventors: Britta BEER, Weyhe (DE); Moritz DITTMAR, Klein Nordende (DE)

(21) Appl. No.: 19/102,426

(22) PCT Filed: Aug. 9, 2023
(86) PCT No.: PCT/EP2023/072018

§ 371 Date: Feb. 10, 2025

(30) Foreign Application Priority Data
Aug. 11, 2022 (DE) 10 2022 120 357.3

(51) Int. Cl. A23D 9/013; A23G 3/02; A23G 3/34; A23G 3/40; A23G 3/54

(52) U.S. Cl. CPC A23D 9/013; A23G 3/0027; A23G 3/0031; A23G 3/007; A23G 3/0095; A23G 3/0268; A23G 3/40; A23G 3/54

(57) ABSTRACT

A composition for coating confectionary and/or surfaces of food processing machines. The composition includes 60% to 99.09% by weight, based on a total amount of the composition, of an oil. The composition further includes 0.05% to 40% by weight, based on the total amount of the composition, of rice bran wax.

### CROSS REFERENCE TO RELATED APPLICATIONS

This application is a U.S. National Phase application under 35 U.S.C. § 371 of International Application No. PCT/EP2023/072018, filed on Aug. 9, 2023, and claims benefit to German Patent Application No. DE 10 2022 120 357.3, filed on Aug. 11, 2022. The International Application was published in German on Feb. 15, 2024 as WO 2024/033405 A1 under PCT Article 21(2).

### FIELD

The invention relates to a composition for coating foods, to the use thereof, to a process for coating foods and/or machine surfaces, to a process for shaping a food precursor composition and to coated foods and food processing machines.

### BACKGROUND

Foods are often provided with coatings to afford protection against external influences, such as for example temperature variations and variations in relative atmospheric humidity or mechanical stresses. Furthermore, coatings can ensure better packability and prevent sticking together. Especially confectionery, jelly and gummy products such as for example fruit gummies, gummy candies, licorice and dried fruit are generally coated directly after production with an anti-sticking agent to prevent the products from sticking together and drying out. The surfaces of food processing machines too are often provided with release agents for protection and to avoid adhesions.

The anti-sticking/release agents currently produced are predominantly mixtures of waxes or fats and waxes with vegetable oils, for example MCT (medium-chain triglycerides) oil, sunflower oil, rapeseed oil, safflower oil, soybean oil, coconut oil. The waxes employed are typically carnauba wax, beeswax, candelilla wax and microcrystalline wax.

Waxes are generally kneadable at 20° C., are solid to brittley hard, have a coarse to fine-crystalline structure, are translucent to opaque in color but not glassy, undergo melting above 40° C. without decomposition, have a low viscosity even slightly above their melting point, have a highly temperature-dependent consistency and solubility and are polishable under light pressure. Advantages of using carnauba wax, beeswax, candelilla wax and microcrystalline wax include that they exhibit good processibility and a good anti-sticking/release effect on the surface of confectionery, foods and machine surfaces (conveyor belts, cutting blades). However, they have the disadvantage that they are increasingly encountering relatively low consumer acceptance. Beeswax cannot be classified as vegan, carnauba wax has faced criticism with respect to its sustainability, microcrystalline wax is not natural and candelilla wax is currently subject to import restrictions in the EU.

### SUMMARY

In an embodiment, the present disclosure provides a composition for coating confectionary and/or surfaces of food processing machines. The composition includes 60% to 99.09% by weight, based on the total amount of the composition, of an oil. The composition further includes 0.05% to 40% by weight, based on the total amount of the composition, of rice bran wax.

### DETAILED DESCRIPTION

In an embodiment, the present disclosure provides a composition for coating foods which contains a wax which is vegan, sustainable and naturally occurring. The composition shall alternatively or in addition also be suitable for coating machine surfaces which come into contact with foods. The composition shall moreover have a very good anti-sticking/release effect at low viscosity at least at wax contents of up to 25% by weight.

The composition for coating foods and/or surfaces of food processing machines in an embodiment comprises the following components (A) and (B):
(A): 60% to 99.95% by weight, based on the total amount of the composition, of an oil and
(B): 0.05% to 40% by weight, based on the total amount of the composition, of rice bran wax.
   In an embedment, the composition for coating foods, especially confectionery, and/or surfaces of food processing machines comprises the following components (A) and (B):
(A): 60% to 99.09% by weight, based on the total amount of the composition, of an oil
(B): 0.05% to 40% by weight, based on the total amount of the composition, of rice bran wax.

According to the present disclosure it has now been found that the composition exhibits a very good anti-sticking/release effect coupled with a low viscosity at least at wax contents of up to 25% by weight. It also contains a wax which is vegan, sustainable and naturally occurring. The low viscosity of the composition was surprising since compositions comprising the waxes typically employed in practice (e.g. carnauba wax, beeswax) have higher viscosities at similarly employed amounts.

In an embodiment the composition is suitable for coating foods. In an embodiment the composition is thus preferably formulated such that it is itself a food conforming to the definition in US FDA 21 CFR 170.3(m) as of Aug. 1, 2023. In an embodiment it is likewise preferable when the composition is preferably formulated such that it is a food conforming to the definition in Regulation (EC) No. 178/2002 Article 2.

It is further preferable when all components of the composition have met and/or are capable of meeting FDA approval as of Aug. 1, 2023.

In an embodiment the composition is suitable for coating surfaces of food processing machines. In an embodiment the composition is thus preferably formulated such that it is a processing aid according to US FDA 21 CFR 101.100 (a)(3)(ii) as at Aug. 1, 2023. In a further embodiment the composition is preferably formulated such that it is a processing aid according to Regulation (EC) No. 1333/2008 Article 3 Section 2 (b) as at Aug. 1, 2023.

Preferred confectionery include jelly and gummy products, for example fruit gummies, gummy candies; hard and soft sugar dragees, extruded confectionery, licorice and/or dried fruits.

In an embodiment of the present disclosure the composition at a content of rice bran wax as component B of 0.05% to 5% by weight has a viscosity, measured as specified in the section Methods of measurement, of 50 mPas to 250 mPas. In an embodiment of the present disclosure the composition at a content of rice bran wax of 5% to 20% by weight has a viscosity, measured as specified in the section Methods of measurement, of 250 mPas to 430 mPas. In an embodiment of the present disclosure the composition at a content of rice bran wax of 20% to 25% by weight has a viscosity, measured as specified in the section Methods of measurement, of 430 mPas to 500 mPas.

In an embodiment of the present disclosure the composition at a total content of wax, i.e. of rice bran wax B) and of wax D3) distinct from rice bran wax, of 0.05% to 5% by weight has a viscosity, measured as specified in the section Methods of measurement, of 50 mPas to 250 mPas. In an embodiment of the present disclosure the composition at a total content of wax of 5% to 20% by weight has a viscosity, measured as specified in the section Methods of measurement, of 250 mPas to 430 mPas. In an embodiment of the present disclosure the composition at a total content of wax, i.e. of rice bran wax and of wax distinct from rice bran wax, of 20% to 25% by weight has a viscosity, measured as specified in the section Methods of measurement, of 430 mPas to 500 mPas.

The term “at a content” or “at a total content” is not to be understood as meaning a restriction of the composition to the respective content but rather only as meaning that a composition having the respective content preferably has the respective viscosity.

It is preferable when the rice bran wax has a melting point of 65° C. to 85° C., preferably of 75° C. to 85° C. It is more preferable when the rice bran wax is produced from rice oil.

In an embodiment the rice bran wax comprises fatty acid esters, preferably fatty acid esters having 6 to 30 carbon atoms, more preferably having 10 to 28 carbon atoms, especially having 16 to 24 carbon atoms, in the fatty acid component and/or 10 to 40 carbon atoms, more preferably having 20 to 38 carbon atoms, especially having 26 to 32 carbon atoms, in the alcohol component. It is preferable when the proportion of fatty acid esters, based on the total weight of the rice bran wax, is more than 90% by weight, yet more preferably more than 95% by weight.

In an embodiment the rice bran wax has a dropping point, measured according to ASTM D3461 of 12.01.2018, of 70° C. to 90° C., yet more preferably of 75° C. to 80° C. It is likewise preferable when the rice bran wax has a saponification number, measured according to Ph. Eur. No. 0592 of 2020, of 65 to 144 mg KOH/g, yet more preferably of 75 to 120 mg KOH/g. It is likewise preferable when the rice bran wax has an acid number, measured according to Ph. Eur. No. 6.0/0977 of 2020, of less than 15 mg KOH/g, yet more preferably of 5 to 12 mg KOH/g. It is likewise preferable when the rice bran wax has an iodine number, measured according to Ph. Eur. 2.5.4 of 2020, of less than 20 mval/kg, yet more preferably of 8 to 16 mval/kg.

The rice bran wax can also contain further components, for example palmitic acid, ceryl alcohol, free fatty acids, squalene and/or phospholipids.

In a preferred embodiment of the present disclosure the content of rice bran wax, based on the total amount of the composition, is from 1% to 5% by weight or from 1% to 15% by weight or from 25% to 35% by weight or from 0.05% to 20% by weight or from 1% to 20% by weight or from 5% to 15% by weight, in each case based on the total amount of the composition. A content of rice bran wax of 1% to 5% by weight is particularly suitable for applications for coating machine surfaces, a content of 1% to 15% by weight is particularly suitable for coating gummy products and extruded confectionery and a content of 25% to 35% by weight is particularly suitable for use on sugar dragees or machine surfaces.

Preferred oils of component A) are corn germ oil, almond oil, olive oil, rapeseed oil, sunflower oil, wheat germ oil, MCT oil, safflower oil, soybean oil, palmolein, coconut oil and/or mixtures thereof. Preferred oils are MCT oil, sunflower oil, rapeseed oil, coconut oil and/or mixtures thereof. An advantage of MCT oil is its high stability. In a preferred embodiment of the present disclosure the content of component A), based on the total amount of the composition, is from 60% to 99% by weight or from 60% to 99.95% by weight, yet more preferably from 70% to 97% by weight or from 60% to 92% by weight and especially from 85% to 95% by weight or from 85% to 92% by weight, in each case based on the total amount of the composition.

In an embodiment of the present disclosure the composition comprises vegetable fat (component (C)). If present, component (C) is preferably present in a content of 10% to 39% by weight or 5% to 39% by weight or 5% to 30% by weight, yet more preferably 10% to 35% by weight or 5% to 35% by weight or 10% to 30% by weight, in particular 20% to 35% by weight or of 10% to 24% by weight.

The composition according to the present disclosure preferably comprises, in each case based on the total amount of the composition:
(A) 60% to 92% by weight of at least one oil,
(B) 0.05% to 20% by weight of rice bran wax,
(C) 5% by weight to 30% by weight of at least one vegetable fat.

In the context of the present disclosure fat is characterized in that it is selected from esters of the alcohol glycerol with three, preferably different, fatty acids and is solid at room temperature. The fat is preferably selected from cocoa butter, rapeseed fat and/or palm fat.

The composition according to the present disclosure can also comprise further waxes distinct from rice bran wax as component (D). If present, the content of further waxes is preferably from 0.05% to 39% by weight or 0.05% by weight to 20% by weight or 1% by weight to 20% by weight or 0.05% by weight to 15% by weight or 1% by weight to 15% by weight or 0.05% by weight to 10% by weight or 1% by weight to 10% by weight, in each case based on the total amount of the composition.

The composition according to the present disclosure preferably comprises, in each case based on the total amount of the composition:
(A) 60% to 92% by weight of at least one oil,
(B) 0.05% to 20% by weight of rice bran wax,
(C) 5% by weight to 30% by weight of at least one vegetable fat,
(D) 1% to 15% by weight of at least one wax distinct from rice bran wax.

In the context of the present disclosure a wax is to be understood as meaning an organic compound which has at least one, preferably both, of the following properties:
1. At 20° C., the compound is: kneadable, solid to brittley hard, has a coarse to fine-crystalline structure, is translucent to opaque in color.
2. It undergoes melting without decomposition above 40° C.; has a low viscosity even slightly above the melting point, has a highly temperature-dependent consistency and solubility and is polishable under light pressure.

The further wax is preferably insoluble in water but soluble in organic, nonpolar media. Waxes preferred according to the present disclosure are palm wax, carnauba wax, beeswax, candelilla wax, paraffin waxes and microcrystalline waxes and/or mixtures thereof.

The composition can also comprise further customary additives, such as antioxidants, emulsifiers, acidulants, preservatives, colorings and/or aromas, as component (E).

If present, the composition according to the present disclosure contains each of the additives (E) independently of one another preferably in an amount of 0.01% to 20% by weight, particularly preferably 0.01% to 15% by weight, yet more preferably of 0.01% to 10% by weight, in each case based on the total weight of the lubricant composition. The composition according to an embodiment of the present disclosure preferably contains additives (E) in a total amount of 0.01% to 20% by weight, particularly preferably 0.01% to 15% by weight, yet more preferably of 0.01% to 10% by weight, in each case based on the total weight of the lubricant composition.

The composition according to an embodiment of the present disclosure preferably comprises, in each case based on the total amount of the composition:
(A) 60% to 99.95% by weight of at least one oil,
(B) 0.05% to 40% by weight of rice bran wax,
(C) 0% to 39% by weight, preferably 10% to 39% by weight, of at least one vegetable fat,
(D) 0% to 39% by weight, preferably 0.05% to 39% by weight, of at least one wax distinct from rice bran wax,
(E) 0% to 20% by weight, preferably 0.01% to 20% by weight, of at least one additive, preferably selected from antioxidants, emulsifiers, acidulants, preservatives, colorings, aromas and mixtures thereof.

The composition according to an embodiment of the present disclosure preferably comprises, in each case based on the total amount of the composition:
(A) 60% to 92% by weight of at least one oil,
(B) 0.05% to 20% by weight of rice bran wax,
(C) 5% by weight to 30% by weight of at least one vegetable fat,
(D) 1% to 15% by weight of at least one wax distinct from rice bran wax,
(E) 0.01% to 20% by weight of at least one additive, preferably selected from antioxidants, emulsifiers, acidulants, preservatives, colorings, aromas and mixtures thereof.

An embodiment of the present disclosure further provides for the use of a composition according to one or more of the embodiments mentioned herein for coating foods, preferably confectionery products, especially jelly and gummy products such as for example fruit gummies, gummy candies; sugar dragees, extruded confectionery products, licorice and/or dried fruits, and/or surfaces of food processing machines, especially conveyor belts, and/or cutting blades. An embodiment of the present disclosure further provides for foods and/or machines coated in this way.

It has surprisingly been found that rice bran wax as such, i.e. rice bran wax without any addition, especially without addition of an oil A) as described above, is suitable for coating foods and/or for coating machine surfaces which come into contact with foods. The rice bran wax imparts a very nice gloss to the foods.

It has surprisingly also been found that rice bran wax in combination with at least one further component distinct from the above-described oils A) is suitable for coating foods and/or for coating machine surfaces which come into contact with foods.

An embodiment of the present disclosure therefore further provides for the use of rice bran wax for coating foods and/or for coating machine surfaces which come into contact with foods.

In an embodiment the rice bran wax is used for coating surfaces of molds used for food processing.

Having regard to preferred embodiments, especially of the rice bran wax, the foregoing relating to suitable and preferred embodiments is hereby incorporated by reference in its entirety.

In a first variant rice bran wax is used without addition of a further component for coating foods and/or for coating machine surfaces which come into contact with foods. In a second variant rice bran wax in combination with at least one further component distinct from oils A) is used for coating foods and/or for coating machine surfaces which come into contact with foods. The further component is especially selected from the aforementioned components C), D), E) and mixtures thereof. Preference is given to the combination of rice bran wax with at least one component E) and optionally at least one component C) and/or D).

In an embodiment rice bran wax is used in combination with a further component selected from antioxidants, emulsifiers, acidulants, preservatives, colorings, aromas and mixtures thereof for coating foods and/or for coating machine surfaces which come into contact with foods.

An embodiment of the present disclosure further specifically provides for the use of rice bran wax, preferably rice bran wax according to one or more of the embodiments described herein, for coating confectionery, in particular hard sugar dragees. The rice bran wax can be used alone or in combination with further components, for example glycerol.

Compositions according to the present disclosure and compositions distinct therefrom which comprise rice bran wax in combination with at least one further component distinct from oils A) are hereinbelow also referred to collectively as “rice bran wax-containing compositions”.

Rice bran wax and rice bran wax-containing compositions are especially suitable for coating surfaces of machines used for food processing which come into contact with foods.

Adhesion of the food to the coated machine surface can thus especially be avoided. The surface coated with rice bran wax or a rice bran wax-containing composition is specifically selected from the surfaces of molds for food production, conveyor belts, cutting blades etc. A preferred embodiment thus comprises the use of rice bran wax or a rice bran wax-containing composition for coating surfaces of molds used for food processing.

In an embodiment the rice bran wax-containing compositions are suitable for coating foods. In an embodiment the rice bran wax-containing compositions are preferably formulated such that they themselves are foods conforming to the definition in US FDA 21 CFR 170.3(m) as at Aug. 1, 2023. In an embodiment it is likewise preferable when the rice bran wax-containing compositions are preferably formulated such that they are foods conforming to the definition in Regulation (EC) No. 178/2002 Article 2.

It is further preferable when all components of the rice bran wax-containing compositions have met and/or are capable of meeting FDA approval as at Aug. 1, 2023.

In an embodiment the rice bran wax-containing compositions are suitable for coating surfaces of food processing machines. In an embodiment the compositions are thus preferably formulated such that they are processing aids according to US FDA 21 CFR 101.100 (a)(3)(ii) as at Aug. 1, 2023. In an embodiment the rice bran wax-containing compositions are preferably formulated such that they are processing aids according to Regulation (EC) No. 1333/2008 Article 3 Section 2 (b) as at Aug. 1, 2023.

Rice bran wax and rice bran wax-containing compositions are exceptionally suitable for coating foods and/or machine surfaces. An embodiment of the present disclosure thus also provides a process for coating foods, especially confectionery, and/or machine surfaces, which comprises applying to the surface of foods, preferably of confectionery, such as jelly and gummy products, and/or to the surface of food processing machines which come into contact with foods at least one coating composition selected from
a) a composition according to the present disclosure,
b) rice bran wax,
c) rice bran wax in combination with at least one further component distinct from oils A),
d) mixtures thereof.

The applying of the coating composition can be carried out such that the foods and/or machine surfaces are partially or completely coated.

In a preferred embodiment the applying of the coating composition is carried out by subjecting the coating composition to frictional forces, wherein at least partial melting of the coating composition is preferably effected. The frictional forces can occur between the foods and/or between the foods and the surface of a moving coating apparatus, for example the surface of a rotating drum. This provides for particularly good adhesion of the coating and a smooth and glossy surface.

In a preferred embodiment the applying of the coating composition is carried out such that the coating composition is subjected to centrifugal forces. This provides for uniform distribution of the foods and the coating composition and to obtain a uniform coating result.

In an embodiment the process comprises the following steps:
the foods to be coated and the coating composition are introduced into a rotatable drum, preferably a coating pan;
the drum is set in rotation, thus coating the foods with the coating composition.

The foods to be coated and the coating composition can be introduced into the rotatable drum simultaneously or successively. It is preferable when the foods to be coated are introduced initially and the coating composition is introduced subsequently.

The drum can be set in rotation before or during introduction of the foods to be coated and/or the coating composition or only after introduction thereof.

Having regard to preferred embodiments, especially of the rice bran wax and the foods, the foregoing relating to suitable and preferred embodiments is hereby incorporated by reference in its entirety.

Rice bran wax and rice bran wax-containing compositions are preferably suitable for producing foods, especially confectionery, which are subjected to a shaping step. The surface of the employed mold is partly or completely coated with rice bran wax or a rice bran wax-containing composition before it comes into contact with the food. Rice bran wax and rice bran wax-containing compositions are suitable for example for shaping a food precursor composition, for example a confectionery precursor composition, wherein this is introduced into a mold in a flowable state and hardened therein. Suitable molds are made for example of metal, for example aluminum, or of plastic. The molds can be provided with a customary lining, for example with a polymer, for example a lining of rubber or a silicone polymer. Rice bran wax and rice bran wax-containing compositions are very readily compatible with the materials typically used for food production.

An embodiment of the present disclosure thus further provides a process for shaping a food precursor composition, preferably a confectionery precursor composition, wherein said composition is introduced into a mold in a flowable state and hardened therein, wherein before it comes into contact with the food precursor composition the surface of the employed mold is partially or completely coated with at least one coating composition selected from
a) a composition according to the present disclosure,
b) rice bran wax,
c) rice bran wax in combination with at least one further component distinct from oils A),
d) mixtures thereof.

Having regard to preferred embodiments, especially of the rice bran wax, the foregoing relating to suitable and preferred embodiments is hereby incorporated by reference in its entirety.

An embodiment of the present disclosure further provides confectionery coated with rice bran wax and rice bran wax-containing compositions. An embodiment of the present disclosure likewise provides foods, food processing machines and/or molds whose surface is at least partially coated with at least one coating composition selected from
a) a composition according to the present disclosure,
b) rice bran wax,
c) rice bran wax in combination with at least one further component distinct from oils A), mixtures thereof.

It is preferable when at least the parts of the machines and/or molds that come into contact with foods are coated.

Having regard to preferred embodiments, especially of the rice bran wax and the foods, the foregoing relating to suitable and preferred embodiments is hereby incorporated by reference in its entirety.

### Methods of Measurement

### Viscosity of the Composition

The viscosity of the composition is determined as follows:

The viscosity of the composition is measured between two parallel plates at a particular temperature (20° C.) and time (180 s). One plate is rotated at a particular speed (shear rate 65^{-S}) while the other plate is held fast. The composition present in the gap (1 mm) between the plates begins to flow against its internal resistance, i.e. its viscosity.

An embodiment of the present disclosure is more particularly elucidated below with reference to nonlimiting examples.

### Example 1: Production of Composition 1 According to the Present Disclosure

A composition 1 is produced. This comprises providing the following components:
(A) Sunflower oil: 90% by weight
(B) Rice bran wax: 10% by weight

The rice bran wax is melted at 80° C. and the sunflower oil added with continuous stirring.

The viscosity of the composition obtained is 320 mPas.

### Comparative Example 2: Production of Composition 2

Sunflower oil 90%
Carnauba wax 10%

Composition 2 is produced analogously to example 1. The viscosity of the obtained composition is 600 mPas and is thus markedly higher than that of the composition according to the present disclosure.

### Comparative Example 3: Production of Composition 3

Sunflower oil 90%
Beeswax 10%

Composition 3 is produced analogously to example 1. The viscosity of the obtained composition is 850 mPas and is thus markedly higher than that of the composition according to the present disclosure.

### Example 4: Coating of Confectionery With Composition 1

Fruit gummies (1 kg) are initially charged. Subsequently, 1 g of composition 1 is manually incorporated into the fruit gummies. Uniformly coated fruit gummies are obtained. The anti-sticking effect of composition 1 is tested as follows. The fruit gummies are placed in a plastic bag and stored at RT for 4 weeks. The plastic bag is then shaken. It is observed that the fruit gummies easily detach from one another and no residue is discernible on the inside of the plastic bag.

### Example 5: Coating of Confectionery With Composition 3

Fruit gummies (1 kg) are initially charged. Subsequently, 1 g of composition 3 is manually incorporated into the fruit gummies. Uniformly coated fruit gummies are obtained. The anti-sticking effect of composition 3 is tested as follows. The fruit gummies are placed in a plastic bag and stored at RT for 4 weeks. The plastic bag is then shaken. It is observed that the fruit gummies stick together.

### Example 6: Coating of Confectionery With Rice Bran Wax

Hard sugar dragees (2 kg) are initially charged in a coating pan. Subsequently, the coating pan is set in rotation (pan speed 30 rpm). Respective portions of 3.5 g of rice bran wax are manually added in two applications (at intervals of 15 minutes). Uniformly coated hard sugar dragees having a distinct gloss are obtained.

While subject matter of the present disclosure has been described in detail in the foregoing description, such descriptions are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A composition for coating foods and/or surfaces of food processing machines, the composition comprising:
60% to 99.09% by weight, based on a total amount of the composition, of an oil; and
0.05% to 40% by weight, based on the total amount of the composition, of rice bran wax.

2: The composition of claim 1, wherein the composition at a content of rice bran wax of 0.05% to 5% by weight has a viscosity of 50 mPas to 250 mPas and/or at a content of rice bran wax of 5% to 20% by weight has a viscosity of 250 mPas to 430 mPas and/or at a content of rice bran wax of 20% to 25% by weight has a viscosity of 430 mPas to 500 mPas, wherein the viscosity is measured by arranging the composition between two parallel plates at a temperature of 20° C. over 180 seconds, one of the two parallel plates being rotated at a shear rate of 65-s and the two parallel plates having a gap of 1 mm therebetween.

3: The composition of claim 1, wherein the rice bran wax comprises fatty acid esters having 6 to 30 carbon atoms in a fatty acid component and/or 10 to 40 carbon atoms in an alcohol component.

4: The composition of claim 1, wherein content of fatty acid ester, based on the total weight of the rice bran wax, is more than 90% by weight.

5: The composition of claim 1, wherein the rice bran wax has a dropping point, measured according to ASTM D3461 of 12.01.2018, of 70° C. to 90° C.

6: The composition of claim 1, wherein the composition is formulated such that the composition is a food conforming to the definition in US FDA 21 CFR 170.3(m) as of Aug. 1, 2023 and/or a processing aid according to US FDA 21 CFR 101.100 (a)(3)(ii) as of Aug. 1, 2023.

7: A method, comprising:
providing the composition of claim 1; and
coating a food and/or surfaces of a food processing machine with the composition.

8: A method, comprising:
providing the composition of claim 3; and
coating foods and/or coating machine surfaces which come into contact with foods with the composition.

9: The method of claim 8, comprising coating surfaces of a food processing mold with the rice bran wax.

10: The method of claim 8, comprising coating hard sugar dragees with the rice bran wax.

11: A process for coating foods and/or machine surfaces comprising:
applying to the foods and/or machine surfaces at least one coating composition selected from:
a) the composition as claimed in claim 1,
b) rice bran wax,
c) rice bran wax in combination with at least one further component distinct from oils in the composition of claim 1, and
d) mixtures thereof.

12: The process of claim 11, wherein the applying is carried out by subjecting the coating composition to frictional forces, wherein at least partial melting of the coating composition is effected.

13: The process of claim 11, further comprising:
introducing the foods to be coated and the coating composition into a rotatable drum; and
rotating the drum, thus coating the foods with the coating composition.

14: A process for shaping a food precursor composition, comprising:
introducing the food precursor composition into a mold in a flowable state such that the food precursor composition is hardened in the mold; and
at least partially coating a surface of the mold with a coating composition before the surface of the mold comes into contact with the food precursor composition, the coating composition being selected from:
a) the composition as claimed in claim 1,
b) rice bran wax,
c) rice bran wax in combination with at least one further component distinct from oils in the composition of claim 1, and
d) mixtures thereof.

15: A food, food processing machine and/or mold, wherein a surface of the food, food processing machine, and/or mold includes a surface that is at least partially coated with at least one coating composition selected from:
a) the composition as claimed in claim 1,
b) rice bran wax,
c) rice bran wax in combination with at least one further component distinct from oils in the composition of claim 1, and
d) mixtures thereof.
